(19) United States
(12) Patent Application Publication
(10) Pub. No.: US 2016/0367999 A1
(43) Pub. Date: Dec. 22, 2016

(54) USE OF A PUSH FLOOR AND INDUSTRIAL COMMINUTION MACHINE

(71) Applicant: METSO MINERALS (DEUTSCHLAND) GMBH, Bochum (DE)

(72) Inventors: August Van Der Beek, Grevenbroich (DE); Erich Kohl, Meerbusch (DE)

(73) Assignee: METSO MINERALS (DEUTSCHLAND) GMBH, Bochum (DE)

(21) Appl. No.: 14/902,195

(22) PCT Filed: Jun. 6, 2014
(86) PCT No.: PCT/EP2014/061776

§ 371 Date: Dec. 30, 2015

(30) Foreign Application Priority Data
Jul. 2, 2013 (JP) 13174742.0

(51) Int. Cl. B02C 23/02; B02C 18/22; B02C 13/286

(52) U.S. Cl. CPC B02C 23/02; B02C 13/286; B02C 18/2216; B02C 2013/28618

(57) ABSTRACT

The disclosure relates to the use of a sliding base, and to an industrial comminution machine, wherein the sliding base is used.

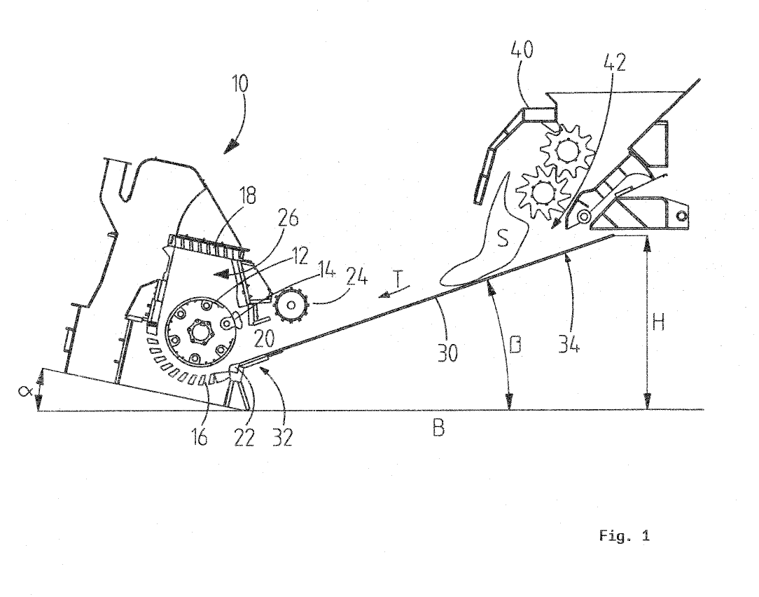

The invention relates to the use of a push floor, and to an industrial comminution machine, wherein the push floor is used.

The term “industrial comminution machine” relates to units that are used in the industrial domain in order to comminute scrap items. These include, for example, hammer crushers for the processing (comminution) of car bodies, scrap metal and/or other metallic and/or non-metallic recyclable resources,

This type of comminution unit (shredder unit) is described by EP 0 969 932 B1.

The material to be comminuted, such as scrap metal or motor vehicle bodies, is relatively inhomogeneous, both with regard to the size and with regard to the physical properties of the materials.

The functioning of the comminution unit is therefore dependent, among other things, upon how the material is conveyed into the comminution machine.

It is known from EP 0 963 252 B1 that used materials to be comminuted are to be delivered via a loading chute of the comminution unit, there being disposed above the loading cute a driven roller that applies a controllable pressure to the delivered material.

This unit has basically proved its worth. However, it is a certain disadvantage that the loading chute has to have a relatively large incline so that the material passes to the roller and from here into the comminution unit.

Conversely, this means that the resources have to be placed on the loading chute a relatively large height above the base. This “loading height” makes loading difficult. Attempts have been made to resolve this problem by the material being conveyed to the feed side end of the loading chute via a conveyor belt. However, this considerably increases investment and maintenance costs.

The object underlying the invention is to offer a possibility of simplifying the charging of an industrial comminution unit of the aforementioned type.

The invention is based on the follow basic ideas: Initially conveying the material to be comminuted at a certain height so as to then convey it back down into the comminution machine along a slide must be avoided.

This can be achieved relatively easily by the loading chute (material slide) being made with a smaller incline (smaller angle to the horizontal). However, the consequence of this is that then the material can no longer slide freely into the feed opening of the comminution machine because the static friction is greater than the sliding friction.

Against this background, the invention is based upon the additional knowledge of choosing a dynamic feed device instead of a static feed device. The term “dynamic feed device” includes the idea that the material that is lying on the feed device slides into the comminution machine not only due to gravitation on the feed device, but is subjected to external motive forces and in this respect is conveyed by means of additional energy from the outside into the desired position.

In this connection so-called steel plate belts and push floors are known. A push floor (also called a sliding base or sliding bottom) characterizes a base that is driven externally, mostly hydraulically, and so is moved in order to convey a material that is lying on the base in a specific direction.

This base is made up of individual strips (slats) that can be moved relative to one another. The strips/slats lying next to one another mostly engage with one another without any spaces in between, i.e. they are moved so as to slide/shift relative to one another. Each of these zones/slats is driven separately and the individual zone/slat shifts individually in a pre-determinable direction.

For a push floor that has, for example, three slats lying next to one another, the following sequence, for example, takes place:
A first slat is moved forwards, the material lying on the push floor not being carried along with it, or only minimally.
The second slat is moved forwards in the same way, and once again no or very little material is carried along with it, and at best over a sub-section.
The third slat is likewise repositioned.
All three slats are then moved in the opposite direction and thereby carry the conveyed items along with them.
These sequences are repeated until the material is in the desired position.

For the field of application according to the invention the push floor can be operated continuously, i.e. material is continuously fed in at one end of the push floor, and at the other end of the push floor this material is continuously transferred into the comminution machine.

The function and construction of the push floor described means that this charging unit functions in any orientation. Thus, the feed end—as in the prior art—is higher than the transfer end (into the comminution machine); the push floor can likewise be orientated horizontally, and conversely, the feed end can even lie slightly below the transfer end (as respectively observed vertically).

Therefore, in its most general embodiment the invention relates to the use of a push floor for charging an industrial comminution unit with scrap items to be comminuted.

The use of the push floor enables additional advantages with respect to the mechanical loading chute according to the prior art:

The conveyance of the items to be comminuted on a loading chute is essentially dependent upon the incline of the loading chute, the type of material, the geometry of the material, the humidity of the material and other factors. In other words: The conveyance speed of the feed items on the loading chute can only be controlled arbitrarily.

In contrast, the conveyance speed of the material on a push floor can be controlled within broad ranges by the lift, the frequency and the speed of movement of the individual slats of the push floor.

In this way the material feed into the comminution unit can take place far more evenly and homogeneously than in the prior art.

Another advantage is that the material to be comminuted no longer needs to be conveyed at relatively large heights in order to transfer it to the charging device. This simplifies the entire unit, saves on cost for feed belts etc.

The push floor can be charged with a simple crane or wheel bearing.

Described below are further developments of the invention which can be realized individually and in combination in so far as these combinations are not ruled out tautologically or explicitly.

The industrial comminution unit can be a hammer crusher, for example a hammer crusher according to EP 0 969 932 B1.

In its functional position the push floor can be orientated at an angle of between 3 and 25° in relation to the horizontal.

In its functional position the push floor can be orientated such that its end which is vertically lower opens out into a feed opening of the comminution unit. This feed opening is often characterized by a so-called anvil. In the prior art there is partially a relatively large distance between the feed device and the edge of the anvil. This distance can be considerably reduced by the use of a push floor according to the invention. The orientation of the push floor can be adapted to the orientation of the anvil, i.e. both can be orientated more or less flush with one another so that the material transfer is simplified.

For this purpose the comminution unit, as known for example from EP 0 963 252 B1, is easily tilted in the direction of the push floor, as also shown in the following description of the figures. In this way the angle of inclination of the push floor can be additionally reduced in the same way. The delivery of the material onto the push floor is thus facilitated.

In its functional position the push floor can be orientated such that its end that is vertically lower adjoins a wear-optimized region for transferring the scrap items into the comminution unit. This means that there are disposed between the push floor and the anvil edge (of a hammer mill) in the region of the comminution unit additional wearing plates that are particularly resistant to wear due to measures known in their own right, such as heat treatment of the surface.

Some comminution units of the aforementioned type, in particular hammer mills, and in particular hammer mills that are used for processing scrap metal, are combined with a so-called pre-shredder. In this case the use of the push floor can take place such that the push floor is disposed between the industrial comminution unit and the pre-shredding machine and is operatively connected to both.

In this case too it is an advantage of the pre-shredder that the machine can be disposed at a much lower level above the base and so the charging height is reduced. Moreover, the pre-shredder is then better for the operating staff and is easier to see such that one can intervene in the event of malfunctions.

Similarly to with the loading chute according to the prior art, the push floor can also be combined with at least one driving roller that is disposed above the push floor and acts upon the scrap items to be comminuted.

However, in this combination the primary purpose of the driving roller is to hold the material on the push floor and less importantly to actively convey items. In this respect the situation is converse to the situation of a purely mechanically loading chute with a driving roller.

The comminution unit is characterized by the following features:
A feed opening for scrap items to be comminuted into a comminution space,
a push floor running from the feed opening to the outside.

The comminution space can be conventional in form, i.e. for example with a rotor and hammers fastened so as to vibrate on the latter. Details are given, for example, by EP 0 969 932 B1.

As stated, the push floor can have its vertically lowest point on its end facing the feed opening of the comminution unit. Moreover, the comminution unit can be combined with a pre-shredding machine which is then operatively connected to the opposite end of the push floor.

For the specific design of the push floor there are no restrictions provided the basic principle of the base is put into practice. A push floor conveyor emerges, for example, from DE 10 2010 060 759 B4. A suitable carrier profile is disclosed by DE 10 2009 056 821 A1.

Additional features of the invention emerge from the features of the sub-claims and the other application documents.

The invention is described in more detail below by means of an exemplary embodiment.

This shows—in a diagrammatic side view—a hammer crusher with an associated push floor in combination with a pre-shredder.

Reference number 10 shows an industrial comminution unit, namely a hammer mill (a shredder) for the processing of scrap metal. The unit 10 corresponds substantially to the unit according to 0 969 932 B1 and is therefore not shown here in any more detail. It comprises in particular a rotor 12, to which hammers 14 are fastened so as to vibrate, an associated lower grate 16 and an upper grate 18.

A feed opening is identified by 20. On the lower end of the feed opening 20 an anvil 22 is shown diagrammatically. Contrary to normal practice the shredder 10 is arranged tilted at an angle α of approximately 20° (to the right in the figure), by means of which the feed opening 20, including the region around the anvil 22, is not only moved somewhat closer to a base B, but the feed opening 20 is also additionally opened to the right in the figure.

In this way a push floor 30 can be arranged at an angle β of only approximately 10° between the feed opening 20 and an ejection region 42 of a pre-shredder 40.

The orientation of the push floor 30 is such that on the (left) end 32, which is lower, an almost flush, continuous conveyance plane is produced with the adjacent anvil 22 and the first section of the lower grate 16 disposed behind (on the left in the figure).

In this way a comminution item shown diagrammatically by S (for example a car body) can be continuously conveyed on the push floor 30 in a plane from the upper section 34 in the pre-shredder 40 via the feed opening 20 into the shredder 10 (arrow direction T).

In principle the push floor 30 is designed according to the prior art. Here, above the lower end 32, it has another rotatably mounted driving roller 24 that acts on the scrap items S.

Due to the use of a push floor the height H on the feed side end of the charging unit (push floor 30) can be reduced to a minimum, and in particular the height can be considerably reduced with respect to conventional loading chutes according to the prior art, for example from 10 to 2 m.

1. A system for charging an industrial comminution unit with scrap items to be comminuted, the system comprising a push floor having a first end positioned below a second end, the first end positioned adjacent to a feed opening of the industrial comminution unit.

2. The system according to claim 1, wherein the industrial comminution unit is a hammer crusher.

3. The system according to claim 1, wherein in its functional position the push floor is orientated at an angle of between 3 and 25° in relation to the horizontal.

4. The system according to claim 1, wherein in its functional position the push floor is orientated such that the vertically lower first end opens out into the feed opening of the comminution unit.

5. The system according to claim 1, wherein in its functional position the push floor is orientated such that the vertically lower first end adjoins a wear-optimized region for transferring the scrap items into the comminution unit.

6. The system according to claim 1, wherein the push floor is disposed between the industrial comminution unit and a pre-shredding machine and is operatively connected to both.

7. The system according to claim 1, wherein at least one driving roller is disposed above the push floor so that it acts upon the scrap items to be comminuted.

8. A system to comminute scrap items, comprising:
an industrial comminution unit with a feed opening for scrap items to be comminuted into a comminution space; and
a push floor running from the feed opening to the outside.

9. The system according to claim 8, wherein the push floor has its vertically lowest point at its end facing the feed opening of the comminution unit.

10. The system according to claim 8, wherein an end of the push floor facing away from the comminution unit is operatively connected to a pre-shredding machine.

11. A system to comminute scrap items, comprising:
an industrial comminution unit having a feed opening to receive the scrap items into a comminution space;
a push floor having a first end and a second end positioned above the first end, wherein the first end is adjacent to the feed opening; and
a pre-shredding machine having an ejection region positioned to discharge the scrap items onto the push floor near the second end of the push floor.

12. The system of claim 11 further comprising at least one driving roller positioned above the push floor near the feed opening.

13. The system of claim 11 wherein the push floor is oriented at an angle of between 3° and 25° relative to horizontal.

14. The system of claim 11 wherein the feed opening is oriented at an angle of approximately 20° to horizontal.

15. The system of claim 14 wherein the push floor is oriented at an angle such that the angle between the feed opening and the push floor is approximately 10°.
